(19) United States
(12) Patent Application Publication
(10) Pub. No.: US 2025/0165994 A1
(43) Pub. Date: May 22, 2025

(54) FEEDBACK FOR DIFFERENT TRANSACTION TYPES

(71) Applicant: Motorola Mobility LLC, Chicago, IL (US)

(72) Inventors: Krishnan Raghavan, Bangalore (IN); Vignesh Karthik Mohan, Bangalore (IN); Nakul Patel, Bangalore (IN)

(73) Assignee: Motorola Mobility LLC, Chicago, IL (US)

(21) Appl. No.: 18/517,581

(22) Filed: Nov. 22, 2023

(51) Int. Cl. G06Q 30/0201

(52) U.S. Cl. CPC G06Q 30/0201

(57) ABSTRACT

Techniques for feedback for different transaction types are described and are implementable to enable fulfillment feedback regarding fulfillment transactions to be utilized to automatically generate transaction feedback for corresponding data transactions. For instance, when a user engages in a fulfillment transaction as part of a purchase of a product, the user can provide fulfillment feedback regarding the fulfillment transaction. The fulfillment feedback can be utilized to automatically generate transaction feedback for a corresponding data transaction.

### BACKGROUND

The use of network-based finance systems has become commonplace across the world. For instance, users can perform a wide variety of different financial transactions using a network-based finance application, such as using a portable device, e.g., a smartphone. While the availability of finance applications can provide a great deal of convenience, it is not without challenges. For instance, financial transactions can include multiple stages such that providing user feedback at each stage of a transaction may be cumbersome and/or practically infeasible.

### BRIEF DESCRIPTION OF THE DRAWINGS

Aspects of feedback for different transaction types are described with reference to the following Figures. The same numbers may be used throughout to reference similar features and components shown in the Figures. Further, identical numbers followed by different letters reference different instances of features and components described herein.

FIG. 1 illustrates an example environment in which aspects of feedback for different transaction types can be implemented.

FIG. 2 depicts aspects of an example system for feedback for different transaction types in accordance with one or more implementations.

FIG. 3 depicts an example fulfillment feedback graphical user interface (GUI) in accordance with one or more implementations.

FIG. 4 depicts an example transaction GUI in accordance with one or more implementations.

FIG. 5 depicts an example transaction GUI in accordance with one or

more implementations.

FIG. 6 depicts an example transaction insights GUI in accordance with one or more implementations.

FIG. 7 depicts an example transaction overview GUI in accordance with one or more implementations.

FIG. 8 illustrates a flow chart depicting an example method for feedback for different transaction types in accordance with one or more implementations.

FIG. 9 illustrates a flow chart depicting an example method for feedback for different transaction types in accordance with one or more implementations.

FIG. 10 illustrates a flow chart depicting an example method for feedback for different transaction types in accordance with one or more implementations.

FIG. 11 illustrates various components of an example device in which aspects of feedback for different transaction types can be implemented.

### DETAILED DESCRIPTION

Techniques for feedback for different transaction types are described and are implementable to enable fulfillment feedback regarding fulfillment transactions to be utilized to automatically generate transaction feedback for corresponding data transactions. For instance, when a user engages in a fulfillment transaction as part of a purchase of a product, the user can provide fulfillment feedback regarding the fulfillment transaction. The fulfillment feedback can be utilized to automatically generate transaction feedback for a corresponding data transaction.

As an example, consider a scenario where a user utilizes a fulfillment application on a client device to interact with a fulfillment service and implement a fulfillment transaction. The fulfillment transaction, for example, represents a purchase of a product, such as goods and/or services. A data transaction is implemented in conjunction with the fulfillment transaction, such as to provide data representing monetary value in exchange for a product as part of the fulfillment transaction. Further to the example scenario, the fulfillment application can present the user with an option to provide fulfillment feedback regarding the fulfillment transaction. The user can provide fulfillment feedback for the fulfillment transaction and the fulfillment feedback can be used to automatically generate transaction feedback for the corresponding data transaction. In at least one implementation the fulfillment feedback can be converted from a data form used by the fulfillment service to a different data form used by the transaction service to generate the transaction feedback.

Accordingly, techniques described herein enable users to provide fulfillment feedback for fulfillment transactions and for the fulfillment feedback to be automatically converted into transaction feedback for associated data transactions. In implementations a data transaction represents a payment transaction. For instance, digital payment transactions involve generating, transmitting, and processing various types of data across a variety of different systems and networks. Thus, such digital payment transactions can be characterized as sets of computational operations much like other operations of a computing device and/or set of computing devices. Accordingly, by enabling user feedback regarding fulfillment transactions to be automatically converted into feedback for data transactions, the described techniques can conserve user and system resources (e.g., memory, processor bandwidth, network bandwidth, etc.) that may otherwise be used to manually provide feedback for data transactions, and thus the described techniques can improve the operation of computing devices and data networks.

While features and concepts of feedback for different transaction types can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

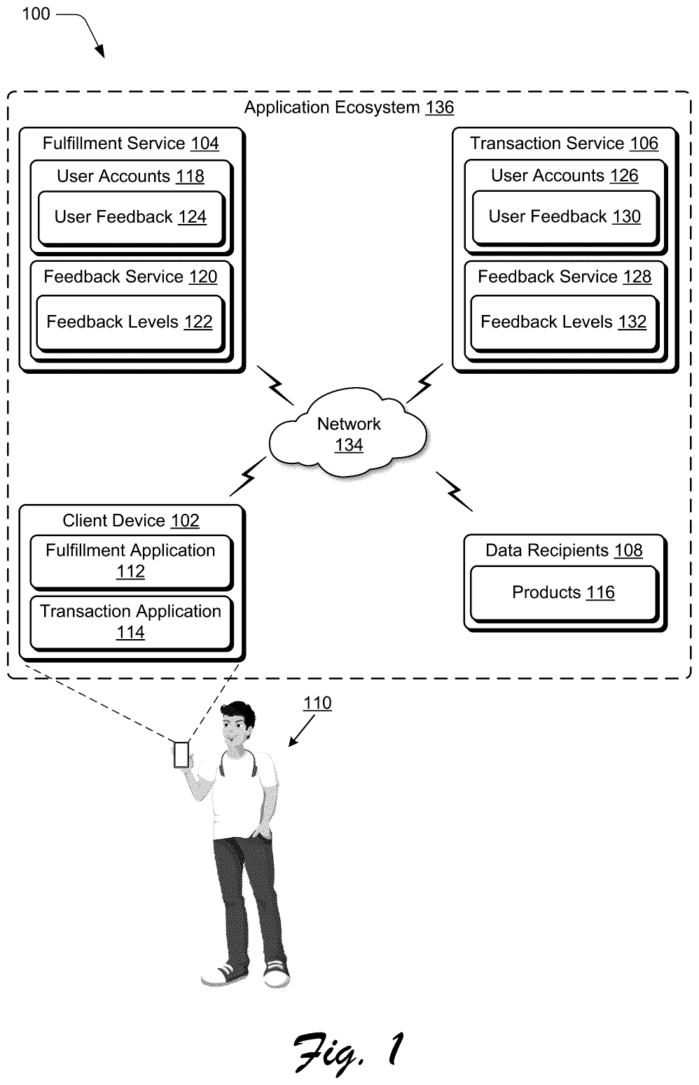

FIG. 1 illustrates an example environment 100 in which aspects of feedback for different transaction types can be implemented. The environment 100 includes a client device 102, a fulfillment service 104, a transaction service 106, and data recipients 108. The client device 102 represents a device that can be used by a user 110 to perform and manage different transactions, e.g., such as fulfillment transactions, data transactions, finance transactions such as purchasing goods and services, and combinations thereof. Examples of the client device 102 include mobile devices such as mobile phones, wearable devices, extended reality (XR) devices, tablets, laptops, etc. The client device 102, however, may be implemented in other ways, such as a desktop computing device, a server device, etc.

The client device 102 includes different functionalities that enable aspects of feedback for different transaction types including a fulfillment application 112 and a transaction application 114. The fulfillment application 112 represents an application that enables a user 110 of the client device 102 to engage in different fulfillment transactions, such as purchases of products, e.g., goods and/or services. The fulfillment application 112, for example, can interface with fulfillment service 104 to perform fulfillment transactions. In implementations the fulfillment service 104 represents a network-based service that is accessible to the client device 102 such as via the fulfillment application 112 to enable the user 110 of the client device 102 to engage in different fulfillment transactions.

The transaction application 114 represents functionality for enabling the client device 102 to engage in different data transactions, such as managing the transfer of different types of data. In at least one example the transaction service 106 facilitates the transfer of data representing value (e.g., monetary and/or other types of value) as part of facilitating fulfillment transactions between the fulfillment application 112 of the client device 102 and the fulfillment service 104.

The transaction service 106 can be implemented by various entities, such as a banking entity, a payment service, an enterprise entity, a trading entity, a data storage and/or management entity, and/or combinations thereof. The user 110, for instance, can utilize a transaction application 114 on the client device 102 to access the transaction service 106 to perform different finance transactions, such as to transfer value amounts (e.g., monetary values) for different purposes, e.g., to purchase goods and services. The transaction application 114, for example, represents functionality that enables various finance-related transactions to be performed via the client device 102, including access to the transaction service 106.

The data recipients 108 represent entities with which the client device 102 may engage in fulfillment transactions and/or data transactions. For instance, the user 110 can utilize the fulfillment application 112 to engage in a fulfillment transaction with a data recipient 108 and which is facilitated by the fulfillment service 104. Further, an exchange of data (e.g., data representing value) as part of the fulfillment transaction can be enabled via the transaction service 106.

For example, the data recipients 108 via the fulfillment service 104 can provide products 116 (e.g., goods and/or services) to the user 110 and in exchange the client device 102 can cause a transfer of data via the transaction service 106 (e.g., data representing an exchange of value) to the data recipients 108. In at least one implementation the data exchange between the client device 102 and the data recipients 108 is facilitated (e.g., managed) by the transaction service 106. The transaction service 106, for example, can implement a transfer of data (e.g., a data representation of value such as monetary value) to the data recipients 108 on behalf of the client device 102.

The fulfillment service 104 includes functionality for implementing various aspects of feedback for different transaction types including user accounts 118 and a feedback service 120. The user accounts 118 include information for different instances of users, such as fulfillment transactions performed by different users. The user accounts 118, for example, include a user account 118 for the user 110. The feedback service 120 represents a service that enables users to provide feedback for different fulfillment transactions implemented via the fulfillment service 104. For instance, when the client device 102 engages in a fulfillment transaction with a data recipient 108 (e.g., an exchange of value for a product 116 provided by the data recipient 108), the user 110 can utilize the client device 102 to provide feedback to the feedback service 120 regarding the fulfillment transaction. The feedback, for instance, can include data that identifies how the user 110 “rates” the data transaction, e.g., as a positive transaction, a satisfactory transaction, a negative transaction, etc.

Accordingly, the feedback service 120 includes different feedback levels 122 which represent different categorizations of fulfillment transactions. The feedback levels 122, for example, include different predefined selectable categorizations that indicate a relative user feedback regarding instances of fulfillment transactions. In an example implementation the feedback levels 122 can be based on a scale of 1-10 with 1 indicating an extreme user dissatisfaction with a data transaction and 10 indicating an extreme user satisfaction with a data transaction. According to implementations user feedback regarding fulfillment transactions can be stored in corresponding user accounts 118 as user feedback 124.

The transaction service 106 includes functionality for implementing various aspects of feedback for different transaction types including user accounts 126 and a feedback service 128. The user accounts 126 includes information for different instances of users, such as data transactions performed by different users. For instance, the user accounts 126 can track data transactions performed by different users in conjunction with corresponding fulfillment transactions with the fulfillment service 104. The user accounts 126, for example, include a user account 126 for the user 110.

The feedback service 128 represents a service that enables feedback to be associated with different data transactions implemented via the transaction service 106. For instance, when the user 110 provides user feedback 124 to the fulfillment service 104 for a fulfillment transaction, the user feedback 124 can be communicated to the feedback service 128 for association with a corresponding data transaction as user feedback 130. Thus, at least some of the user feedback 130 can be associated with data transactions of the transaction service 106 that are based on corresponding fulfillment transactions of the fulfillment service 104. Further, the feedback service 128 includes different feedback levels 132 which represent different categorizations of data transactions. The feedback levels 132, for example, include different predefined categorizations that indicate a relative user feedback regarding instances of data transactions. According to implementations user feedback regarding data transactions can be stored in corresponding user accounts 126 as the user feedback 130.

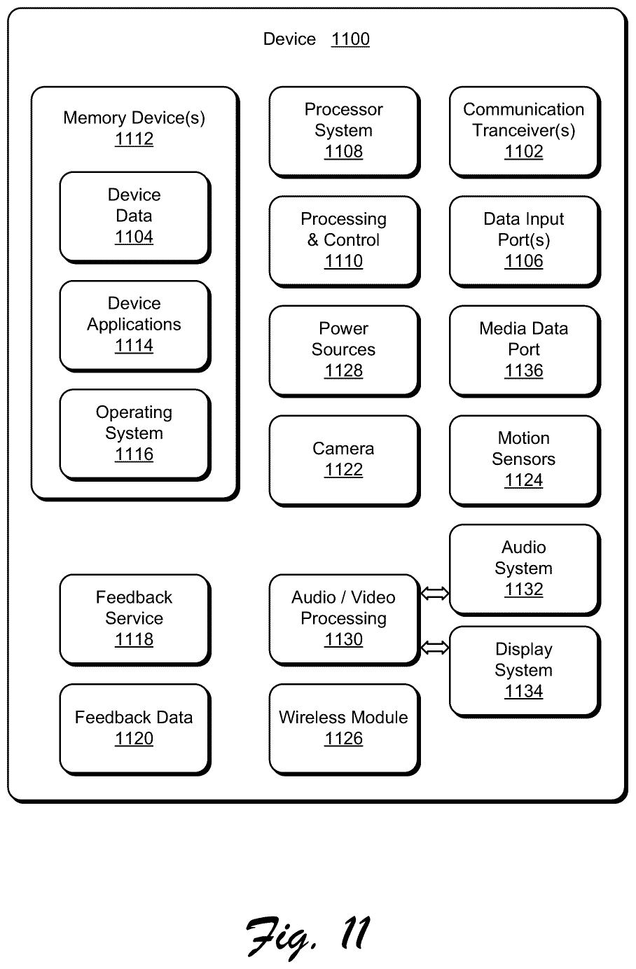

The client device 102, the fulfillment service 104, the transaction service 106, and/or the data recipients 108 can be implemented in various ways and include various functionality, examples of which are discussed below with reference to the example device 1100 of FIG. 11. Further, various entities of the environment 100 can be connected and communicate via a network 134. The network 134, for example, can represent a combination of wired and wireless networks via which the client device 102, the fulfillment service 104, the transaction service 106, and/or the data recipients 108 can participate in various types of communication, such as wired and/or wireless data communication.

According to implementations various entities of the environment 100 (e.g., the fulfillment application 112 and the fulfillment service 104, and the transaction application 114 and the transaction service 106) can be implemented at least in part in the context of an application ecosystem 136 that provides for intercommunication and interoperability of the various entities. The application ecosystem 136, for instance, represents a network infrastructure of functionality (e.g., devices and logic) that enables the various entities to cooperatively perform different types of transactions. In at least one implementation the application ecosystem 136 represents a super application (e.g., super-app, super app, and/or superapp) that integrates functionalities of the various entities to provide for more efficient and seamless performance of different transactions, such as the fulfillment transactions and data transactions discussed herein.

Having discussed an example environment in which the disclosed techniques can be performed, consider now some example scenarios and implementation details for implementing the disclosed techniques.

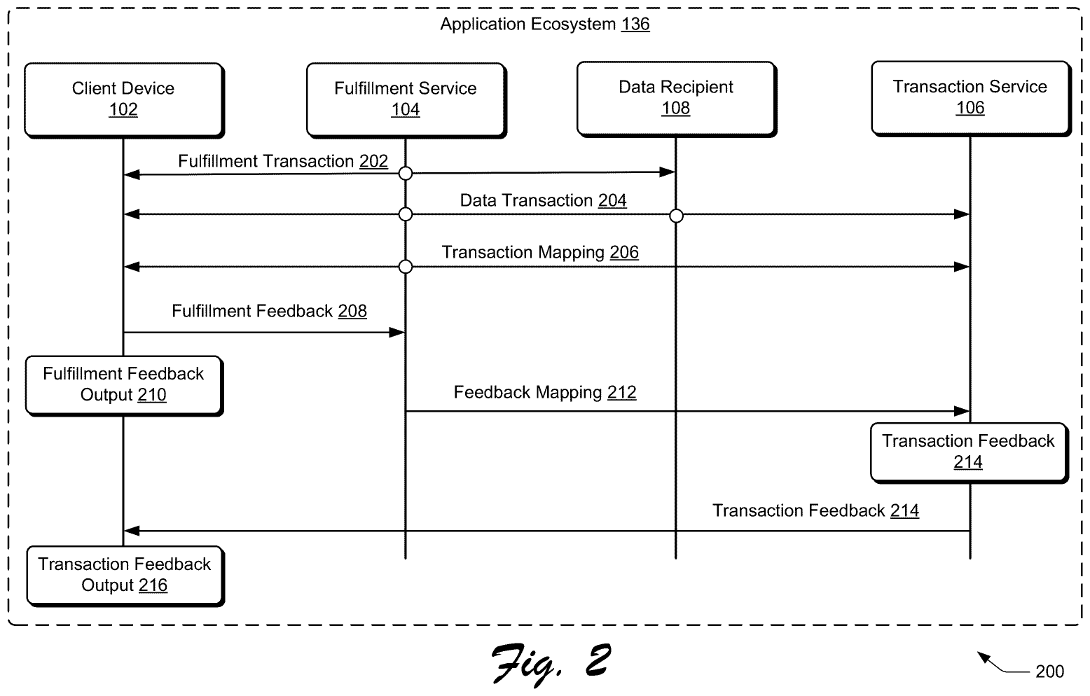

FIG. 2 depicts aspects of an example system 200 for feedback for different transaction types in accordance with one or more implementations. The system 200 can be implemented in the environment 100 and incorporates attributes of the environment 100 introduced d above. Further, various operations and communications discussed in the system 200 can be implemented via the application ecosystem 136, such as via intermediate entities (e.g., devices) that implement and/or manage the application ecosystem 136. In the system 200, the client device 102 engages in a fulfillment transaction 202 with a data recipient 108. The fulfillment transaction 202 can represent various types of data-based transactions, such as an exchange of data, a purchase transaction (e.g., a purchase of a product), and combinations thereof. In at least one implementation the fulfillment transaction 202 involves a provision a product 116 by the data recipient 108 to the user 110 of the client device 102.

Further to the system 200, the fulfillment transaction 202 is implemented via the fulfillment service 104. The fulfillment service 104, for instance, represents a network-based portal via which different fulfillment transactions can be performed. Further, in conjunction with the fulfillment transaction 202, a data transaction 204 is implemented via the transaction service 106. For instance, the client device 102, the fulfillment service 104, the data recipient 108, and the transaction service 106 participate in the data transaction 204 which involves a transfer of data (e.g., data representing value) from the transaction service 106 to the data recipient 108. For example, in the context of a finance transaction and as part of the data transaction 204, the transaction service 106 transfers a data representation of value (e.g., monetary value, digital currency, etc.) on behalf of the client device 102 to the data recipient 108.

According to implementations a transaction mapping 206 is implemented which maps the data transaction 204 to the fulfillment transaction 202. For instance, the fulfillment transaction 202 is associated with a first transaction identifier mapped to another transaction identifier of the data transaction 204. This can enable various actions and/or data associated with the fulfillment transaction 202 to be associated with the data transaction 204.

Continuing with the system 200 fulfillment feedback 208 for the fulfillment transaction 202 is provided via the client device 102 to the fulfillment service 104. The user 110, for instance, interacts with the fulfillment application 112 to provide user feedback 124 regarding the fulfillment transaction 202. The fulfillment application 112 can perform fulfillment feedback output 210 to output the fulfillment feedback 208 via the client device 102. The system 200 can then perform feedback mapping 212 to map the fulfillment feedback 208 for the fulfillment transaction 202 to the data transaction 204 and to enable the transaction service 106 to generate transaction feedback 214 for the data transaction 204. The transaction feedback 214, for instance, represents feedback for the data transaction 204 and is based at least in part on the fulfillment feedback 208.

In at least one implementation the transaction feedback 214 can be generated by converting the fulfillment feedback 208 from a feedback type used by the fulfillment service 104 into a different feedback type used by the transaction service 106. The transaction service 106 communicates the transaction feedback 214 to the client device 102 and the client device 102 can perform transaction feedback output 216. The transaction application 114, for instance, can output an indication of the data transaction 204 and the transaction feedback 214 for the data transaction 204.

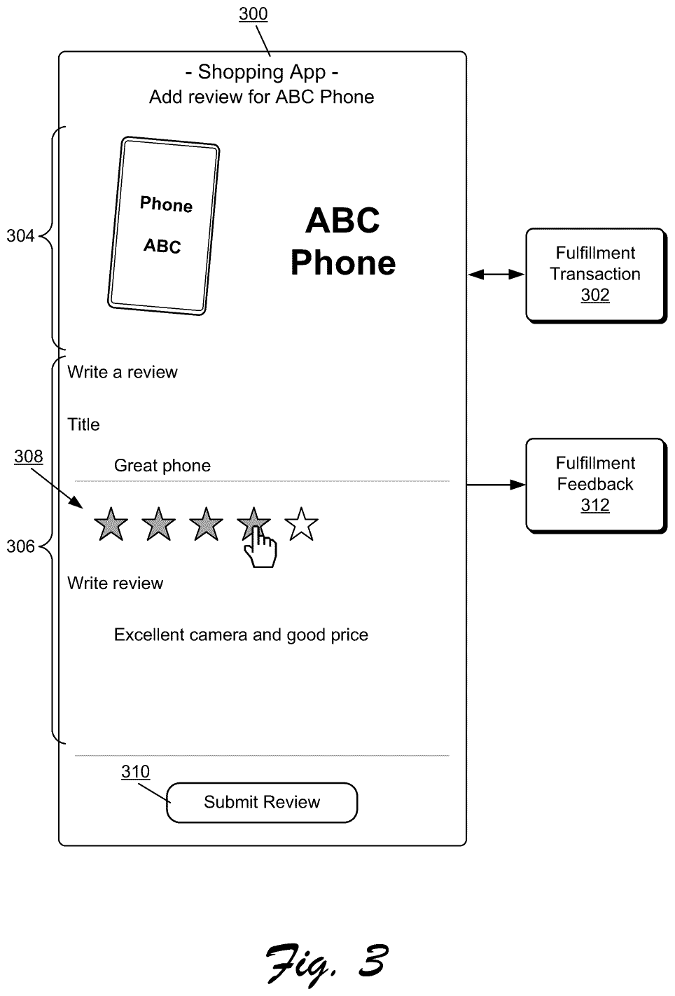

FIG. 3 depicts an example fulfillment feedback graphical user interface (GUI) 300 in accordance with one or more implementations. The fulfillment feedback GUI 300, for instance, is presented via the fulfillment application 112 on the client device 102 and enables a user to provide fulfillment feedback regarding a fulfillment transaction. In this example, the fulfillment feedback GUI 300 is presented for a fulfillment transaction 302.

The fulfillment feedback GUI 300 includes a product region 304 and a feedback region 306. The product region 304 identifies a product involved in the fulfillment transaction 302, such as a product purchased as part of the fulfillment transaction 302. The feedback region 306 is configured to receive user input to provide fulfillment feedback for the fulfillment transaction 302, such as a user description of the fulfillment transaction 302 and user sentiment regarding the fulfillment transaction 302. The feedback region 306 includes a feedback indicator 308 that is selectable to indicate a feedback level for the fulfillment transaction 302. The graphical representation for feedback indicator 308 depends upon the type of fulfilment feedback 208. The fulfilment feedback 208 can be of different types like a multi-point rating system or a bipolar scale such as good or bad.

In this example the feedback indicator 308 includes a set of selectable feedback indicia (e.g., stars) that are selectable to indicate a relative feedback level (e.g., level of user satisfaction) for the fulfillment transaction 302. For instance, a selection of more selectable indicia indicates a higher level of user satisfaction whereas a selection of fewer selectable indicia indicates a lower level of user satisfaction. Accordingly, a user selects a set of the selectable indicia from the feedback indicator 308 (e.g., four stars) to indicate a relatively high level of user satisfaction with the fulfillment transaction 302. The user then selects a submit control 310 which causes fulfillment feedback 312 to be generated based on the user input to the feedback indicator 308. The fulfillment feedback 312 can be communicated to various entities, such as the fulfillment service 104 and the transaction service 106.

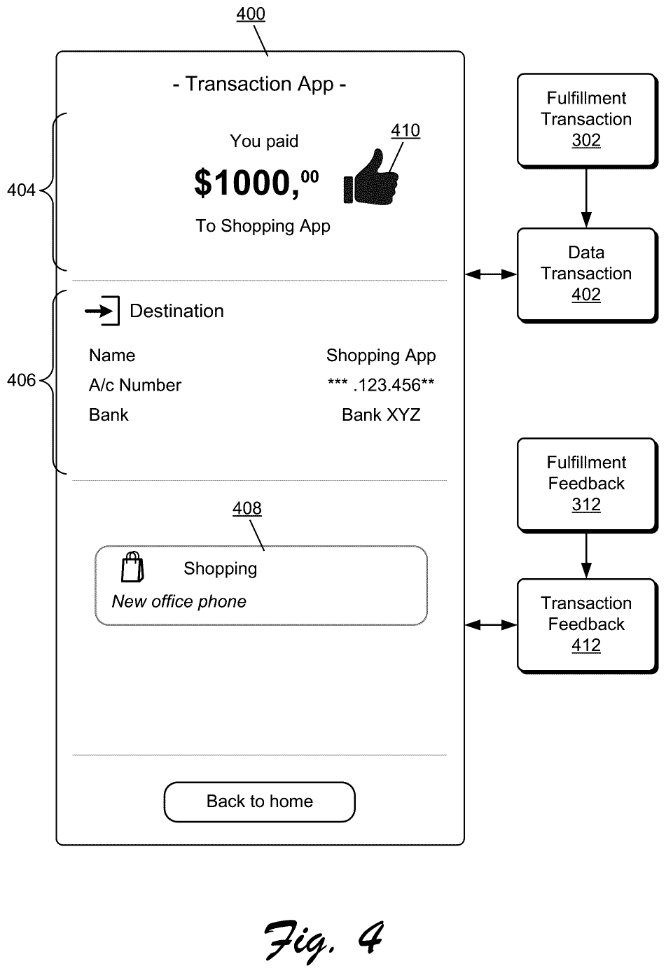

FIG. 4 depicts an example transaction GUI 400 in accordance with one or more implementations. The transaction GUI 400, for instance, is presented via the transaction application 114 on the client device 102 and includes various information about a data transaction 402. The data transaction 402, for example, is implemented in conjunction with the fulfillment transaction 302.

The transaction GUI 400 includes a transaction overview 404, transaction destination information 406, and a transaction details 408. The transaction overview 404 includes an overview of the data transaction 402, such as a value amount of the data transaction (e.g., $1000,00), a data recipient 108 (e.g., “Shopping App”), and a feedback summary 410 for the data transaction 402. For instance, based on the fulfillment feedback 312 the transaction service 106 generates transaction feedback 412 for the data transaction 402. Accordingly, the feedback summary 410 can represent a summary (e.g., visual representation) of the transaction feedback 412.

The transaction destination information 406 includes information about a destination of the data transaction 402, such as for a data recipient 108 of the data transaction 402. The transaction details 408 includes further information about the data transaction 402 such as a transaction type (e.g., “shopping”) and a product 116 involved in the data transaction 402, e.g., “new office phone.” The product 116, for instance, represents a product purchased via the fulfillment transaction 302 and paid for via the data transaction 402.

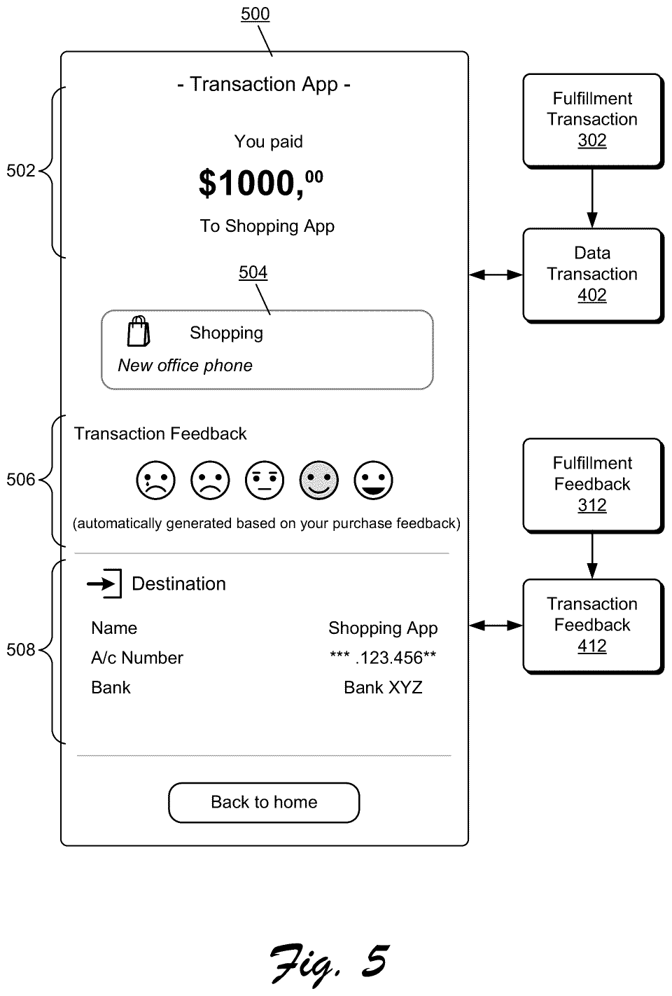

FIG. 5 depicts an example transaction GUI 500 in accordance with one or more implementations. The transaction GUI 500, for instance, is presented via the transaction application 114 on the client device 102 and includes various information about the data transaction 402. In at least one implementation the transaction GUI 500 represents an additional or alternative implementation to the transaction GUI 400.

The transaction GUI 500 includes a transaction overview 502, transaction details 504, a transaction feedback indicator 506, and transaction destination information 508. The transaction overview 502 includes an overview of the data transaction 402 and the transaction details 504 includes further information about the data transaction 402 such as a transaction type and a product 116 involved in the data transaction 402. The transaction feedback indicator 506 includes a representation of the transaction feedback 412. The transaction feedback 412, for instance, is generated by converting the fulfillment feedback 312 into a feedback form utilized by the transaction service 106. Thus, the transaction feedback indicator 506 can represent a visual representation of the transaction feedback 412. In at least one implementation the transaction feedback indicator 506 can specify that the transaction feedback indicator 506 is automatically generated based on the fulfillment feedback 312. The transaction destination information 508 includes information about a destination of the data transaction 402, such as for a data recipient 108 of the data transaction 402.

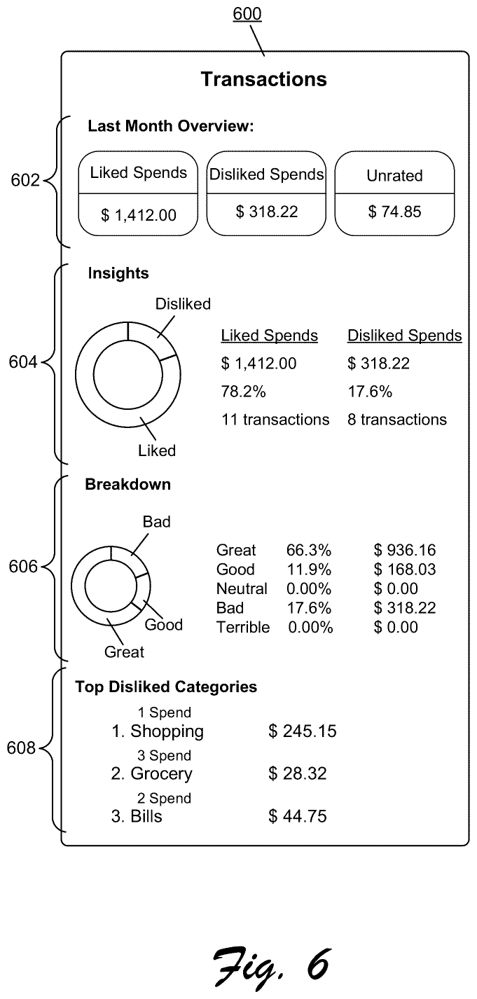

FIG. 6 depicts an example transaction insights GUI 600 in accordance with one or more implementations. The transaction insights GUI 600, for instance, is presented via the transaction application 114 on the client device 102 and includes various information about different data transactions performed via the transaction service 106.

The transaction insights GUI 600 includes a transactions feedback overview 602, transactions feedback insights 604, transactions feedback breakdown 606, and disliked categories 608. The transactions feedback overview 602 includes an overview of transaction feedback for different data transactions over a particular period, e.g., one month. The transactions feedback insights 604 include information indicating a relative amount of different transaction feedback for data transactions. The transactions breakdown 606 includes specific details for transaction feedback provided for different data transactions, such as used to generate the insights presented in the transaction insights 604. The disliked categories 608 identify the top disliked transaction categories over the particular period.

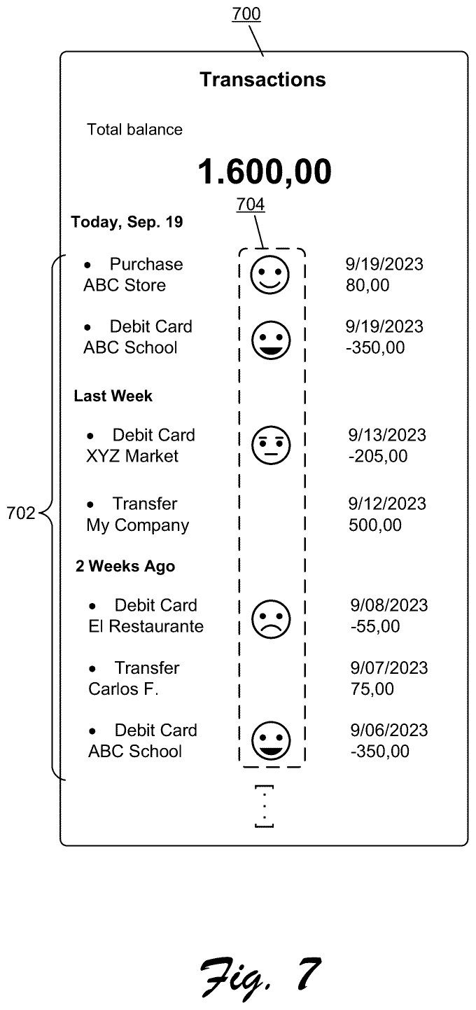

FIG. 7 depicts an example transaction overview GUI 700 in accordance with one or more implementations. The transaction overview GUI 700, for instance, is presented via the transaction application 114 on the client device 102 and includes various information about different data transactions performed via the transaction service 106.

The transaction overview GUI 700 includes a transaction region 702 that identifies different data transactions executed with fulfillment transactions. The transaction overview GUI 700 also includes transaction feedback indicia 704 that identify transaction feedback for different data transactions. In implementations the transaction feedback indicia 704 are generated based at least in part on respective fulfillment transactions, such as described throughout this disclosure.

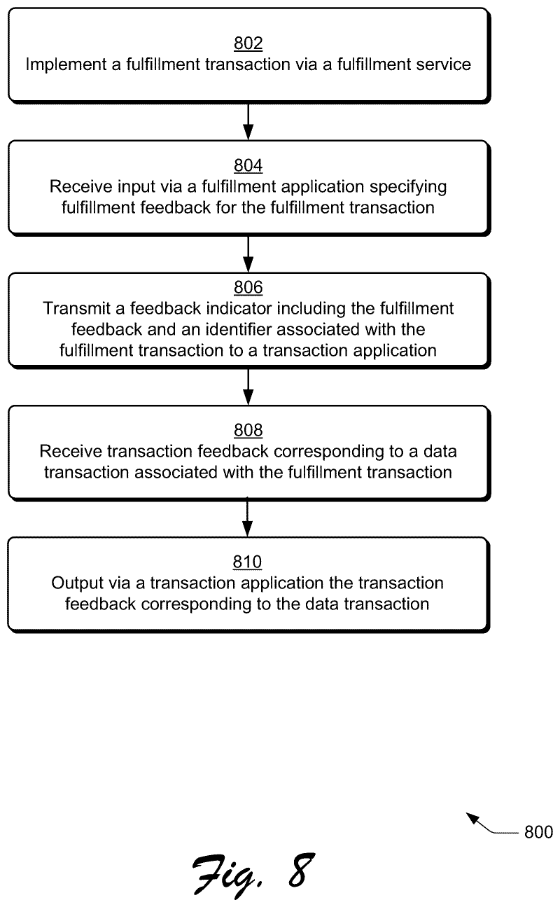

FIG. 8 illustrates a flow chart depicting an example method 800 for feedback for different transaction types in accordance with one or more implementations. Operations of the method 800, for instance, may be performed in the context of the environment 100, such as by the client device 102.

At 802 a fulfillment transaction is implemented via a fulfillment service. A user, for instance, interacts with the fulfillment application 112 to perform a fulfillment transaction via the fulfillment service 104, such as for a purchase of a product 116. At 804 input specifying fulfillment feedback for the fulfillment transaction is received via a fulfillment application. For example, the user provides input to the transaction application to specify fulfillment feedback for the fulfillment transaction.

At 806 a feedback indicator including the fulfillment feedback and an identifier associated with the fulfillment transaction are transmitted to a transaction application. The client device 102 and/or the fulfillment service 104, for instance, transmit the fulfillment feedback and the identifier associated with the fulfillment transaction to the transaction service 106. At 808 transaction feedback corresponding to a data transaction associated with the fulfillment transaction is received. The transaction service 106, for example, receives the fulfillment feedback, associates the fulfillment feedback with a respective data transaction, and utilizes the fulfillment feedback to generate transaction feedback for a corresponding data transaction. In at least one implementation the transaction service 106 converts the fulfillment feedback into a different feedback form utilized by the transaction service 106 to generate the transaction feedback. The transaction service 106 can transmit the transaction feedback to the fulfillment service 104 and/or the client device 102.

At 810 the transaction feedback corresponding to the data transaction is output via a transaction application. The transaction application 114, for instance, outputs the transaction feedback via a GUI, examples of which are detailed throughout this disclosure.

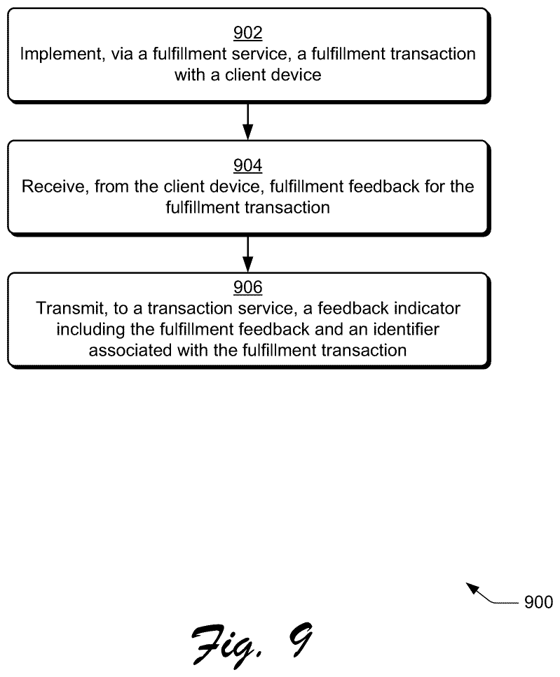

FIG. 9 illustrates a flow chart depicting an example method 900 for feedback for different transaction types in accordance with one or more implementations. Operations of the method 800, for instance, may be performed in the context of the environment 100, such as by fulfillment service 104 and/or the fulfillment application 112.

At 902 a fulfillment transaction with a client device is implemented via a fulfillment service. A user, for instance, interacts with the fulfillment application 112 to perform a fulfillment transaction via the fulfillment service 104. The fulfillment transaction, for instance, includes a purchase of a product 116 from a data recipient 108. At 904 fulfillment feedback for the fulfillment transaction is received from the client device. A user, for example, interacts with the fulfillment application 112 to provide fulfillment feedback for the fulfillment transaction. The client device 102 can transmit the fulfillment feedback to the fulfillment service 104.

At 906 a feedback indicator including the fulfillment feedback and an identifier associated with the fulfillment transaction are transmitted to a transaction service. The fulfillment service 104, for instance, transmits the feedback indicator to the transaction service 106. As discussed herein communication between the fulfillment service 104 and the transaction service 106 can occur via the application ecosystem 136.

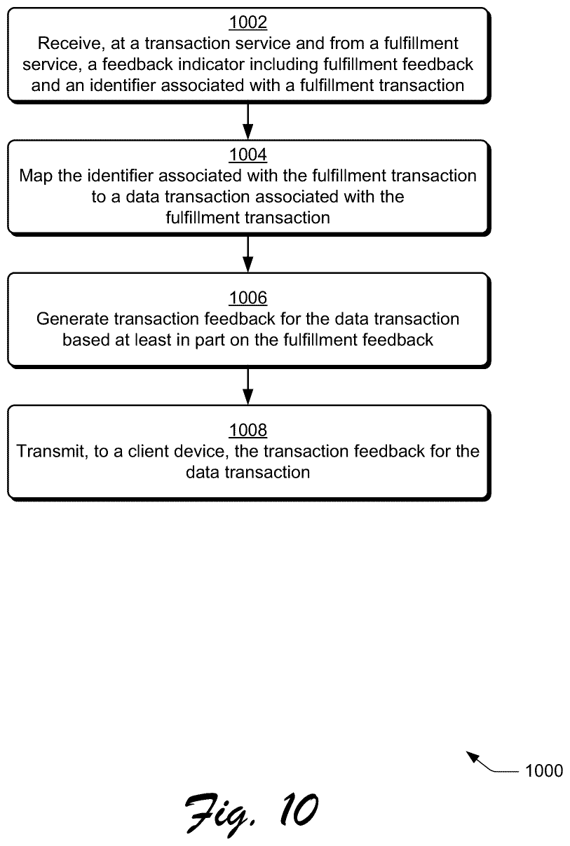

FIG. 10 illustrates a flow chart depicting an example method 1000 for feedback for different transaction types in accordance with one or more implementations. Operations of the method 1000, for instance, may be performed in the context of the environment 100, such as by the transaction application 114 and/or the transaction service 106.

At 1002 a feedback indicator including fulfillment feedback and an identifier associated with a fulfillment transaction is received at a transaction service from a fulfillment service. The transaction service 106, for instance, receives the feedback indicator from the fulfillment service 104. At 1004 the identifier associated with the fulfillment transaction is mapped to a data transaction associated with the fulfillment transaction. For example, the transaction service 106 uses the identifier for the fulfillment transaction to identify a corresponding data transaction.

At 1006 transaction feedback for the data transaction is generated based at least in part on the fulfillment feedback. The transaction service 106, for example, automatically generates transaction feedback for the data transaction based on fulfillment feedback for a corresponding fulfillment transaction. In at least one implementation generating the transaction feedback includes converting the fulfillment feedback from a feedback data form used by the fulfillment service to a different feedback data form used by the transaction service 106.

At 1008 the transaction feedback for the data transaction is transmitted to a client device. The transaction service 106, for example, transmits the transaction feedback to the client device 102, such as for output via the transaction application 114. In at least one implementation, the user needs be prompted to accept, or reject, or modify the transaction feedback generated by the transaction service 106.

The example methods described above may be performed in various ways, such as for implementing various aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 11 illustrates various components of an example device 1100 in which aspects of feedback for different transaction types can be implemented. The example device 1100 can be implemented as any of the devices described with reference to the previous FIGS. 1-10, such as any type of mobile device, mobile phone, mobile device, wearable device, tablet, computing, communication, entertainment, gaming, media playback, and/or other type of electronic device. For example, the client device 102, the fulfillment service 104, and/or the transaction service 106 as shown and described with reference to FIGS. 1-10 may be implemented as the example device 1100.

The device 1100 includes communication transceivers 1102 that enable wired and/or wireless communication of device data 1104 with other devices. The device data 1104 can include any of device identifying data, device location data, wireless connectivity data, and wireless protocol data. Additionally, the device data 1104 can include any type of audio, video, and/or image data. Example communication transceivers 1102 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 1100 may also include one or more data input ports 1106 via which any type of data, media content, and/or inputs can be received, such as user selectable-inputs to the device, messages, music, television content, recorded content, and any other type of audio, video, and/or image data received from any content and/or data source. The data input ports may include USB (Universal Serial Bus) ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1100 includes a processing system 1108 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are identified at 1110. The device 1100 may further include any type of a system bus or other data and command transfer system that couples the various components within the device. A system bus can include any one or combination of different bus structures and architectures, as well as control and data lines.

The device 1100 also includes computer-readable storage memory 1112 (e.g., memory devices) that enable data storage, such as data storage devices that can be accessed by a computing device, and that provide persistent storage of data and executable instructions (e.g., software applications, programs, functions, and the like). Examples of the computer-readable storage memory 1112 include volatile memory and non-volatile memory, fixed and removable media devices, and any suitable memory device or electronic data storage that maintains data for computing device access. The computer-readable storage memory can include various implementations of random access memory (RAM), read-only-memory (ROM), flash memory, and other types of storage media in various memory device configurations. The device 1100 may also include a mass storage media device.

The computer-readable storage memory 1112 provides data storage mechanisms to store the device data 1104, other types of information and/or data, and various device applications 1114 (e.g., software applications). For example, an operating system 1116 can be maintained as software instructions with a memory device and executed by the processing system 1108. The device applications may also include a device manager, such as any form of a control application, software application, signal-processing and control module, code that is native to a particular device, a hardware abstraction layer for a particular device, and so on. Computer-readable storage memory 1112 represents media and/or devices that enable persistent and/or non-transitory storage of information in contrast to mere signal transmission, carrier waves, or signals per se. Computer-readable storage memory 1112 do not include signals per se or transitory signals.

In this example, the device 1100 includes a feedback service 1118 that implements aspects of feedback for different transaction types and may be implemented with hardware components and/or in software as one of the device applications 1114. For example, the feedback service 1118 can be implemented via the client device 102, the fulfillment service 104, the transaction service 106, and/or via the application ecosystem 136. In implementations, the feedback service 1118 may include independent processing, memory, and logic components as a computing and/or electronic device integrated with the device 1100. The device 1100 also includes feedback data 1120 for implementing aspects of feedback for different transaction types and may include data from the feedback service 1118, such as data for managing transaction feedback.

In this example, the example device 1100 also includes a camera 1122 and motion sensors 1124, such as may be implemented in an inertial measurement unit (IMU). The motion sensors 1124 can be implemented with various sensors, such as a gyroscope, an accelerometer, and/or other types of motion sensors to sense motion of the device. The various motion sensors 1124 may also be implemented as components of an inertial measurement unit in the device.

The device 1100 also includes a wireless module 1126, which is representative of functionality to perform various wireless communication tasks. The device 1100 can also include one or more power sources 1128, such as when the device is implemented as a mobile device. The power sources 1128 may include a charging and/or power system, and can be implemented as a flexible strip battery, a rechargeable battery, a charged super-capacitor, and/or any other type of active or passive power source.

The device 1100 also includes an audio and/or video processing system 1130 that generates audio data for an audio system 1132 and/or generates display data for a display system 1134. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1136. In implementations, the audio system and/or the display system are integrated components of the example device. Alternatively, the audio system and/or the display system are external, peripheral components to the example device.

Although implementations of feedback and feedback for different transaction types have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a client device including: at least one processor; and one or more modules executable by the at least one processor to: implement a fulfillment transaction via a fulfillment service; receive input via a fulfillment application specifying fulfillment feedback for the fulfillment transaction; transmit a feedback indicator including the fulfillment feedback and an identifier associated with the fulfillment transaction to a transaction application; receive transaction feedback corresponding to a data transaction associated with the fulfillment transaction; and output via a transaction application the transaction feedback corresponding to the data transaction.

In some aspects, the techniques described herein relate to a client device, wherein the fulfillment transaction includes a purchase of a product and the fulfillment feedback is associated with the purchased product.

In some aspects, the techniques described herein relate to a client device, wherein the one or more modules are executable by the at least one processor to receive the transaction feedback from a transaction service.

In some aspects, the techniques described herein relate to a client device, wherein the one or more modules are executable by the at least one processor to output the fulfillment feedback via a fulfillment application separate from the transaction application.

In some aspects, the techniques described herein relate to a client device, wherein to output the transaction feedback, the one or more modules are executable by the at least one processor to insert the transaction feedback into a transaction entry that includes transaction detail for the data transaction.

In some aspects, the techniques described herein relate to a client device, wherein the one or more modules are executable by the at least one processor to output the transaction feedback based at least in part on a launch of the transaction application on the client device.

In some aspects, the techniques described herein relate to a client device, wherein the one or more modules are executable by the at least one processor to: output the transaction feedback as a proposed transaction feedback suggestion; and determine whether to store the transaction feedback based on whether user input is received to approve or reject the proposed transaction feedback suggestion.

In some aspects, the techniques described herein relate to a client device, wherein the one or more modules are executable by the at least one processor to output the transaction feedback via the transaction application independent of user input to specify the transaction feedback to the transaction application.

In some aspects, the techniques described herein relate to a client device, wherein the one or more modules are executable by the at least one processor to: output the fulfillment feedback via a first graphical user interface associated with the fulfillment application; and output the generated transaction feedback via a second graphical user interface associated with the transaction application.

In some aspects, the techniques described herein relate to a system including: at least one memory; and at least one processor coupled to the at least one memory and configured to cause the system to: implement, via a fulfillment service, a fulfillment transaction with a client device; receive, from the client device, fulfillment feedback for the fulfillment transaction; and transmit, to a transaction service, a feedback indicator including the fulfillment feedback and an identifier associated with the fulfillment transaction.

In some aspects, the techniques described herein relate to a system, wherein the fulfillment transaction includes a purchase of a product and the fulfillment feedback is associated with the purchase of the product.

In some aspects, the techniques described herein relate to a system, wherein the feedback indicator further includes an identifier for the product.

In some aspects, the techniques described herein relate to a system, wherein the at least one processor is configured to cause the system to generate a fulfillment graphical user interface that identifies the fulfillment transaction and the fulfillment feedback for the fulfillment transaction.

In some aspects, the techniques described herein relate to a system, wherein the feedback indicator further includes a product transaction mapping that maps a product associated with the fulfillment transaction to a data transaction associated with the fulfillment transaction.

In some aspects, the techniques described herein relate to a system including: at least one memory; and at least one processor coupled to the at least one memory and configured to cause the system to: receive, at a transaction service and from a fulfillment service, a feedback indicator including fulfillment feedback and an identifier associated with a fulfillment transaction; map the identifier associated with the fulfillment transaction to a data transaction associated with the fulfillment transaction; generate transaction feedback for the data transaction based at least in part on the fulfillment feedback; and transmit, to a client device, the transaction feedback for the data transaction.

In some aspects, the techniques described herein relate to a system, wherein the feedback indicator further includes an identifier for a product associated with the fulfillment transaction.

In some aspects, the techniques described herein relate to a system, wherein the feedback indicator further includes mapping data for mapping the fulfillment transaction to the data transaction.

In some aspects, the techniques described herein relate to a system, wherein to generate the transaction feedback, the at least one processor is configured to cause the system to map a first feedback type for the fulfillment transaction to a second feedback type for the data transaction.

In some aspects, the techniques described herein relate to a system, wherein the data transaction includes one or more of an exchange of data representing value or an exchange of sensitive data.

In some aspects, the techniques described herein relate to a system, wherein the transaction feedback includes an association of the transaction feedback with a product associated with the data transaction and the fulfillment transaction.

1. A client device comprising:
at least one processor; and
one or more modules executable by the at least one processor to:
implement a fulfillment transaction via a fulfillment service;
receive input via a fulfillment application specifying fulfillment feedback for the fulfillment transaction;
transmit a feedback indicator including the fulfillment feedback and an identifier associated with the fulfillment transaction to a transaction application;
receive transaction feedback corresponding to a data transaction associated with the fulfillment transaction; and
output via a transaction application the transaction feedback corresponding to the data transaction.

2. The client device of claim 1, wherein the fulfillment transaction comprises a purchase of a product and the fulfillment feedback is associated with the purchased product.

3. The client device of claim 1, wherein the one or more modules are executable by the at least one processor to receive the transaction feedback from a transaction service.

4. The client device of claim 1, wherein the one or more modules are executable by the at least one processor to output the fulfillment feedback via a fulfillment application separate from the transaction application.

5. The client device of claim 1, wherein to output the transaction feedback, the one or more modules are executable by the at least one processor to insert the transaction feedback into a transaction entry that includes transaction detail for the data transaction.

6. The client device of claim 1, wherein the one or more modules are executable by the at least one processor to output the transaction feedback based at least in part on a launch of the transaction application on the client device.

7. The client device of claim 6, wherein the one or more modules are executable by the at least one processor to:
output the transaction feedback as a proposed transaction feedback suggestion; and
determine whether to store the transaction feedback based on whether user input is received to approve or reject the proposed transaction feedback suggestion.

8. The client device of claim 1, wherein the one or more modules are executable by the at least one processor to output the transaction feedback via the transaction application independent of user input to specify the transaction feedback to the transaction application.

9. The client device of claim 1, wherein the one or more modules are executable by the at least one processor to:
output the fulfillment feedback via a first graphical user interface associated with the fulfillment application; and
output the generated transaction feedback via a second graphical user interface associated with the transaction application.

10. A system comprising:
at least one memory; and
at least one processor coupled to the at least one memory and configured to cause the system to:
implement, via a fulfillment service, a fulfillment transaction with a client device;
receive, from the client device, fulfillment feedback for the fulfillment transaction; and
transmit, to a transaction service, a feedback indicator including the fulfillment feedback and an identifier associated with the fulfillment transaction.

11. The system of claim 10, wherein the fulfillment transaction comprises a purchase of a product and the fulfillment feedback is associated with the purchase of the product.

12. The system of claim 11, wherein the feedback indicator further includes an identifier for the product.

13. The system of claim 10, wherein the at least one processor is configured to cause the system to generate a fulfillment graphical user interface that identifies the fulfillment transaction and the fulfillment feedback for the fulfillment transaction.

14. The system of claim 10, wherein the feedback indicator further comprises a product transaction mapping that maps a product associated with the fulfillment transaction to a data transaction associated with the fulfillment transaction.

15. A system comprising:
at least one memory; and
at least one processor coupled to the at least one memory and configured to cause the system to:
receive, at a transaction service and from a fulfillment service, a feedback indicator including fulfillment feedback and an identifier associated with a fulfillment transaction;
map the identifier associated with the fulfillment transaction to a data transaction associated with the fulfillment transaction;
generate transaction feedback for the data transaction based at least in part on the fulfillment feedback; and
transmit, to a client device, the transaction feedback for the data transaction.

16. The system of claim 15, wherein the feedback indicator further comprises an identifier for a product associated with the fulfillment transaction.

17. The system of claim 15, wherein the feedback indicator further comprises mapping data for mapping the fulfillment transaction to the data transaction.

18. The system of claim 15, wherein to generate the transaction feedback, the at least one processor is configured to cause the system to map a first feedback type for the fulfillment transaction to a second feedback type for the data transaction.

19. The system of claim 15, wherein the data transaction comprises one or more of an exchange of data representing value or an exchange of sensitive data.

20. The system of claim 15, wherein the transaction feedback includes an association of the transaction feedback with a product associated with the data transaction and the fulfillment transaction.
